(19) United States
(12) Patent Application Publication
(10) Pub. No.: US 2005/0232741 A1
(43) Pub. Date: Oct. 20, 2005

(54) Telescopic loader, in particular a reach stacker

(76) Inventor: Walter Laenge, Ludesch (AT)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/108,069

(22) Filed: Apr. 15, 2005

(30) Foreign Application Priority Data
Apr. 16, 2004 (DE) 10 2004 018 644.8

(51) Int. Cl. B66F 9/00

(52) U.S. Cl. 414/718

(57) ABSTRACT

The present application relates to a telescopic loader, in particular a reach stacker, comprising of a vehicle frame and a telescopic boom pivotably arranged thereon with a load receiving means. In accordance with one embodiment, the telescopic boom is made curved.

### CROSS-REFERENCE TO RELATED APPLICATION

This application claims priority to German Applicatin Serial No. 102004018644.8 filed Apr. 16, 2004, the entire disclosure of which is hereby incorporated by reference into the present application, as provided in MPEP § 201.13.

### FIELD

The present application relates to a telescopic loader, in particular a reach stacker.

### BACKGROUND AND SUMMARY

Reach stackers are vehicles with rubber tires, a diesel engine and an operator's cabin. They have the capability of transporting and stacking loads, in particular containers, trailers, sheet metal coils, part loads, etc. Previously known reach stackers are fitted with a container spreader arranged as a load receiving means on the telescopic arm, i.e. a lifting and lowering of the spreader only takes place via the telescopic arm. Fully loaded containers can thus be handled and/or stacked in multiple rows behind one another and on top of one another. However, they do not have the capability to take up lower containers such as are present on the loading and unloading of ships. They are furthermore also not capable of taking up or putting down loads behind a high container stack. In the known reach stacker, the operator's cabins are arranged fixedly or movably connected to the frame in the rear part on the vehicle, whereby the operator always has a good view of the container spreader fixedly connected to the telescopic arm.

Known reach stackers furthermore have a supporting two-beam frame within which the diesel engine and the units required for operation are accommodated. The straight telescopic boom is lifted and lowered by means of two parallel luffing cylinders. The vehicle body paneling usually is made of sheet steel.

A reach stacker is known from DE 197 438 71 A1 which, in further development of the aforesaid design of the reach stacker, has cable hoisting gear at its telescopic arm so that loading units can also be taken up with the load receiving means which are located below the drivable level. It is moreover also possible to grip behind larger structures with the spreader cable lifting gear. Generally containers which lie below the driving plane of the reach stacker can hereby already be loaded and unloaded from inland waterway boats. However, the provision of corresponding cable lifting gear requires a substantially more complex design of the reach stacker. Its handling capability moreover also suffers since the respective load hangs on a cable and thereby tends to swing to and fro. The handling advantage reach stackers have in the transferring of heavy loads is hereby lost again.

One object of the present application is to further develop telescopic loaders, in particular reach stackers, which comprise a vehicle frame and of a telescopic boom which can be lifted and lowered on it and which has load receiving means arranged directly at its tip such that lower loads, for example on a ship, can also be taken up by it without problem and such that it is also possible to grip reliably behind higher structures such as container stacks.

In one example, this object is achieved in accordance with a telescopic loader, in particular a reach stacker, comprising a vehicle frame and a telescopic boom pivotably arranged thereon with a load receiving means, where the telescopic boom is curved. Here, the liftable and lowerable telescopic boom is made in a curved manner. A region below the drivable level can therefore be taken up and put down on a corresponding lowering of the telescopic boom due to this curvature. Loads, for example containers, can also be taken up and put down behind a high container stack. Also, the load receiving means, which can be located at the free end of the curved telescopic boom, can easily be reached by the operator in an advantageous manner due to this curved design. No additional aids such as lifting platforms or ladders are necessary.

In one example, the vehicle frame can be made as a centrally arranged, closed box-type frame. An increased stiffness of the vehicle frame and in particular a substantially increased torsion resistance is thereby achieved. The telescopic tip of the telescopic beam may also be deflected away from its nominal position less strongly due to this higher stiffness.

In accordance with a further advantageous aspect, the engine and the units required for operation may be arranged on the outside of the vehicle frame. It is hereby ensured that they are substantially more easily accessible so that corresponding inspection work or repair work can be carried out more easily and faster.

In accordance with a further advantageous embodiment, a centrally arranged luffing cylinder is provided for the lifting and lowering of the telescopic boom. Increased reliance is hereby achieved on the lifting and lowering of loads since a statically determined load receiving takes place here. With two cylinders arranged in parallel such as are known from the prior art, there may be a risk, as explained at the start, that the load would be taken up or held asymmetrically due to a lack of synchronization of the piston-in-cylinder arrangements such that an overload could occur in one of the piston-in-cylinder arrangements.

Finally, the vehicle body paneling may be advantageously produced in plastic, whereby the known corrosion problems with conventional reach stackers can be solved. The whole reach stacker moreover may have a substantially lighter construction so that it can be operated more economically.

Further features, details and advantages result from the embodiments shown in the drawing and described in the specification.

### BRIEF DESCRIPTION OF THE FIGURES

FIG. 1 is a side view of a reach stacker in accordance with an embodiment;

FIG. 2 is a plan view of the reach stacker in accordance with FIG. 1;

FIG. 3 is a perspective view of the vehicle frame of the reach stacker with a section along the section line 4-4; and

FIG. 4 is a view along section line 4-4′ and

FIGS. 5-7 are various application possibilities for a reach stacker.

### DETAILED DESCRIPTION

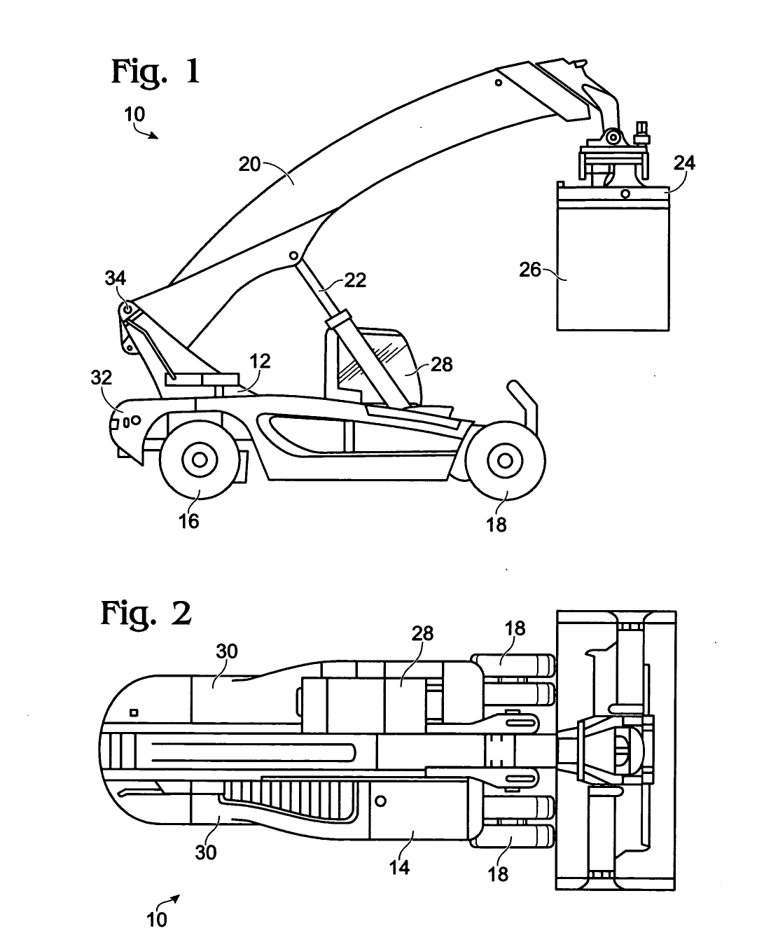

The reach stacker 10 shown in FIG. 1 has a frame 12 on whose right hand side in the direction of travel a diesel engine is arranged as a drive engine 14 (cf. FIG. 2). It has a rear rubber-tired wheel pair 16 and two front wheel pairs 18. The front wheel pairs are seated on the drive axles, while the rear wheel pair is seated on a longitudinal axis. As can in particular be seen from FIG. 2, the two front wheel pairs are each made as longitudinal wheel pairs. A telescopic boom 20 is arranged in a liftable and lowerable manner on the frame 12. The telescopic boom 20 may be curved, with one example curvature shown in FIG. 1. Note that while the Figure show a common curvature across the length of boom 20, in an alternative example the curved boom 20 may include a combination of curved, substantially curved, and substantially straight sections.

The telescopic boom 20 can be lifted and lowered using a single correspondingly dimensioned luffing cylinder 22. A spreader 24, by means of which a container 26 can, for example, be taken up as the load, is hinged to the tip of the telescopic boom 20 as a load receiving means in the embodiment shown here. An operator's cabin 28 is also situated at the side on the frame, with it being arranged on the left hand side with respect to the telescopic boom in the direction of driving, that is on the side opposite the drive motor 14, in order to achieve a weight distribution which is as uniform as possible.

The vehicle body parts 30 (FIG. 2) are made from molded plastic parts. The total vehicle hereby becomes comparatively light and there is reduced risk of corrosion.

A counterweight 32 is arranged in the rear region of the vehicle.

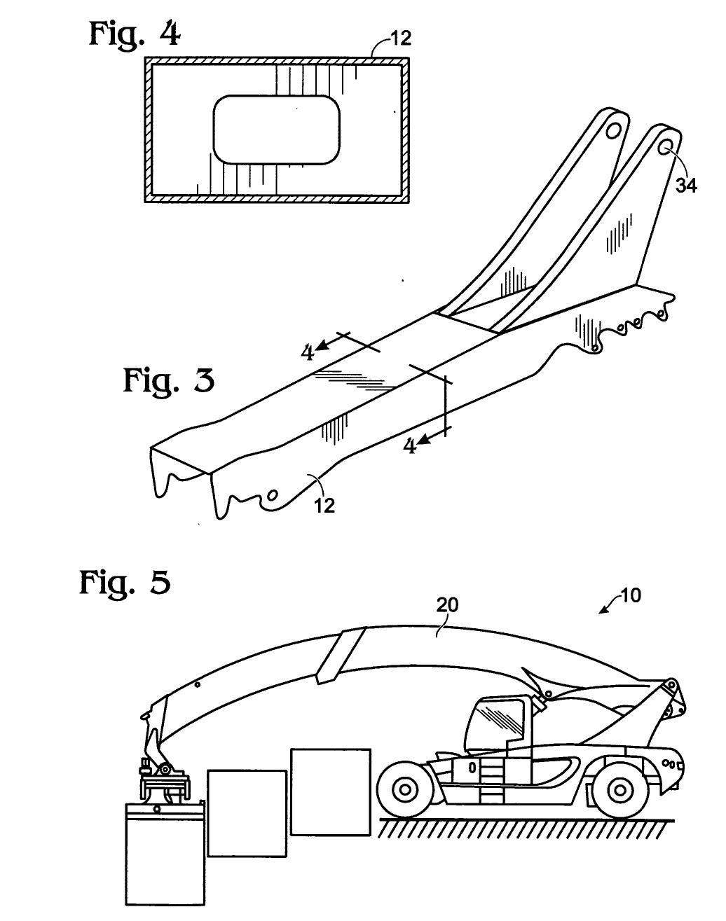

The frame construction of the vehicle frame is shown in FIG. 3. Whereas in the prior art a comparatively soft-bending vehicle frame was used, since an open frame construction was formed there consisting of a supporting free-boom frame, in the reach stacker in accordance with the embodiment shown, a centrally arranged, closed box-type frame design has been selected. Such a box-type frame, which is likewise shown in the sectional representation 4-4 in FIG. 3 (see FIG. 4), is stiffer in bending and has a torsion resistance which is approximately three times higher than a comparable two-boom frame. The telescopic arm 20 which can be lifted and lowered about the pivot point 34 and the load receiving means 24 can hereby also be held in the corresponding nominal position without unwanted fluctuations which can arise due to the bending or torsion of the frame.

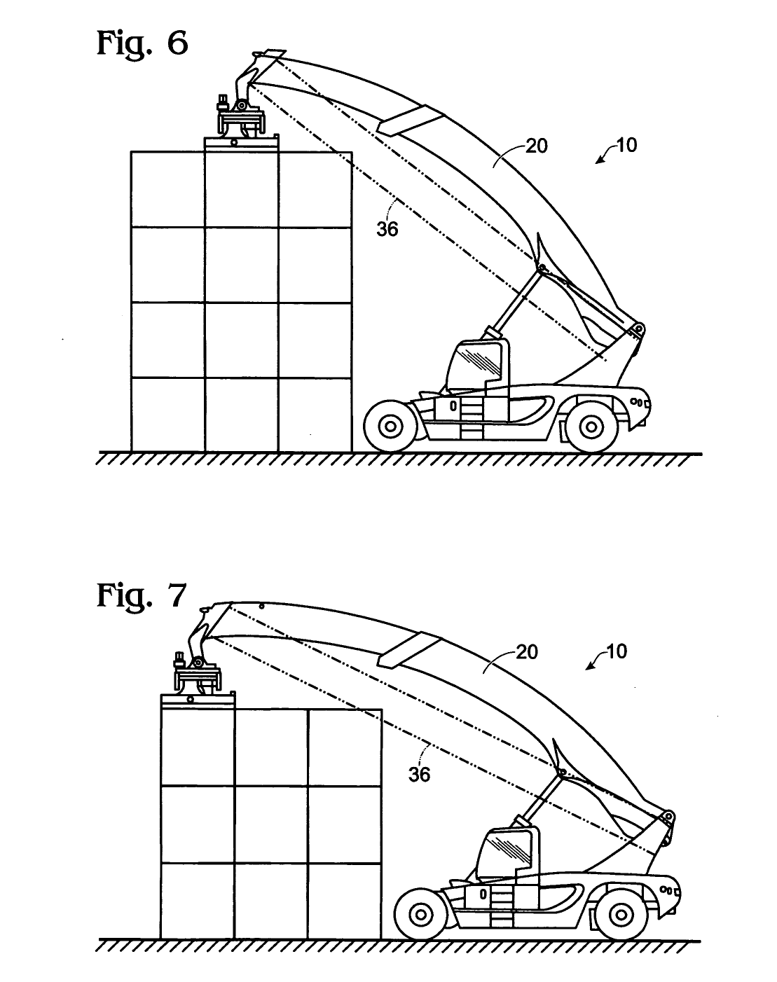

Particularly advantageous application areas of the reach stacker in accordance with the present application can be recognized from FIGS. 5 to 7. The advantages of the bent telescopic boom 20 can in particular be seen here. As shown in FIG. 5, loads or containers which lie below the plane of the road surface can hereby be gripped. FIG. 6 shows the advantages of the bent telescopic boom in comparison with a straight boom 36 shown by way of a dotted contour. Containers placed in a second row can be gripped here due to the bent design of the telescopic boom which would not be able to be gripped with a straight telescopic boom 36. In the example shown here in accordance with FIG. 6, a container in the second row and a container in the fourth row are gripped.

Containers lying even further behind can also be gripped by means of the extensible, curved telescopic boom 20, as FIG. 7 shows. There, a loaded container in the third row and in the third layer is taken up by the reach stacker 10.

1. A telescopic loader, comprising a vehicle frame and a telescopic boom pivotably arranged thereon with a load receiving means, where the telescopic boom is substantially curved.

2. A telescopic loader in accordance with claim 1, wherein the vehicle frame is made as a centrally arranged closed box-type frame.

3. A telescopic loader in accordance with claim 1, wherein the motor and units required for operation are arranged on an outside of the vehicle frame.

4. A telescopic loader in accordance with claim 1, wherein a centrally arranged luffing cylinder is provided to lift and lower the telescopic boom.

5. A telescopic loader in accordance with claim 1, wherein body of the vehicle paneling comprises plastic.

6. A telescopic loader in accordance with claim 1, wherein the telescopic loader is a reach stacker.

7. A telescopic loader configured to be driven on a drivable surface, comprising:
a vehicle frame and a liftable and lowerable telescopic boom pivotably arranged thereon with a load receiving member, where the telescopic boom is curved so that a load can be taken up and put down on a region at a level below the drivable surface.

8. The telescopic loader of claim 7 configured to take up and put down loads behind a container stack.

9. The telescopic loader of claim 7 wherein the load receiving member is located at a free end of the curved telescopic boom.

10. The telescopic loader of claim 7 wherein the loader can be operated without a ladder.

11. The telescopic loader of claim 7 wherein the loader can be operated without a lifting platform.

12. A telescopic loader in accordance with claim 7, wherein the vehicle frame is made as a centrally arranged closed box-type frame.

13. A telescopic loader in accordance with claim 12, wherein the motor and units required for operation are arranged on an outside of the vehicle frame.

14. A telescopic loader in accordance with claim 13, wherein a centrally arranged luffing cylinder is provided to lift and lower the telescopic boom.

15. A telescopic loader in accordance with claim 14, wherein body of the vehicle paneling comprises plastic.

16. A telescopic loader in accordance with claim 15, wherein the telescopic loader is a reach stacker.
